(19) United States
(12) Patent Application Publication
(10) Pub. No.: US 2025/0244509 A1
(43) Pub. Date: Jul. 31, 2025

(54) MULTIDIRECTIONAL OPTICAL ELEMENT

(71) Applicant: National Central University, Taoyuan City (TW)

(72) Inventors: Chih-Ming WANG, Taoyuan City (TW); Chen-Yi YU, Keelung City (TW); Wei-Lun HSU, Kaohsiung City (TW); Yen-Chun CHEN, Taoyuan City (TW)

(21) Appl. No.: 18/424,850

(22) Filed: Jan. 28, 2024

(51) Int. Cl. G02B 3/00; B82Y 20/00; G02B 1/00

(52) U.S. Cl. CPC G02B 3/0056; B82Y 20/00; G02B 1/002; G02B 2207/101

(57) ABSTRACT

A multidirectional optical element includes a substrate and a metalens. The metalens is disposed on the substrate and has a metastructure, wherein the metastructure includes a pattern of a diffractive optical element.

### FIELD

The disclosure relates to an optical element. More specifically, the disclosure relates to a multidirectional optical element.

### BACKGROUND

A diffractive optical element (DOE) is an optical component that relies on diffraction to manipulate light. A DOE with a predesigned pattern may function as a multidirectional optical element that guides an incident light beam into multiple divergent points (focuses). Unfortunately, since there must be a lens disposed between the DOE and a light source to precisely guide the light beam generated by the light source into the DOE, it is difficult to reduce the optical system size (i.e., the size of an assembly of the lens, the DOE and the light source). Therefore, it is important in the art to overcome the problem.

### SUMMARY

To overcome at least the aforesaid problem, the present disclosure provides a multidirectional optical element. The multidirectional optical element may comprise a substrate and a metalens. The metalens may be disposed on the substrate, and the metalens may comprise a metastructure. In addition, the metastructure may comprise a concentric structure with a pattern of a diffractive optical element.

To overcome at least the aforesaid problem, the present disclosure also provides a diffractive optical system. The diffractive optical system may comprise a laser and a multidirectional optical element. The multidirectional optical element may comprise a substrate and a metalens. The metalens may be disposed on the substrate, and the metalens may comprise a metastructure. In addition, the metastructure may comprise a concentric structure with a pattern of a diffractive optical element. The laser may be configured to generate a laser beam, and the multidirectional optical element may be configured to make the laser beam converge at a plurality of focuses.

To overcome at least the aforesaid problem, the present disclosure further provides a wavefront sensor. The wavefront sensor may comprise a detector and a multidirectional optical element. The multidirectional optical element may comprise a substrate and a metalens. The metalens may be disposed on the substrate, and the metalens may comprise a metastructure. In addition, the metastructure may comprise a concentric structure with a pattern of a diffractive optical element. The multidirectional optical element may be configured to make an incident light beam converge at a plurality of focuses, and the detector may be configured to detect the light beam according to the focuses.

Metalens technology can provide a good solution for improving optical system performance while reducing system size; in other words, a single metalens can be used to achieve the same performance as multiple traditional optical components do. In the proposed multidirectional optical element, a special metalens is designed to functions as a traditional lens and a traditional DOE together, and thus the optical system size can be reduced with the same performance.

The summary is not intended to limit the claimed invention, but merely provides basic profile of the claimed invention. The details of the claimed invention will be described with various embodiments as presented below.

### BRIEF DESCRIPTION OF DRAWINGS

FIG. 1 illustrates a schematic view of a multidirectional optical element according to some embodiments of the present disclosure.

FIG. 2 illustrates a schematic view of a diffractive optical system according to some embodiments of the present disclosure.

FIG. 3 illustrates a wavefront sensor according to some embodiments of the present disclosure.

### DETAILED DESCRIPTION

The embodiments as disclosed below are not intended to limit the claimed invention to any specific environment, applications, structures, processes or situations. In the attached drawings, elements which are not directly related to the claimed invention are omitted from depiction. Dimensions and dimensional relationships among individual elements in the attached drawings are only exemplary examples and are not intended to limit the claimed invention. Unless stated particularly, same element numerals may correspond to same elements in the following description without inconsistency with the claimed invention.

The terminology used herein is for the purpose of describing the embodiments only and is not intended to limit the claimed invention. The singular forms “a” and “an” are intended to include the plural forms as well, unless the context clearly indicates otherwise. The terms “comprises,” “comprising,” “includes,” “including,” etc., specify the presence of the stated features, integers, operations, elements, and/or components, but do not preclude the presence or addition of one or more other features, integers, operations, elements, components, and/or groups thereof. The term “and/or” includes any and all combinations of one or more of the associated listed items. Although the terms “first” and “second” etc., may be used herein to describe various elements, these elements should not be limited by these terms. These terms are merely used to distinguish one element from another element. Thus, for example, a first element described below could also be termed a second element, without departing from the spirit and scope of the claimed invention.

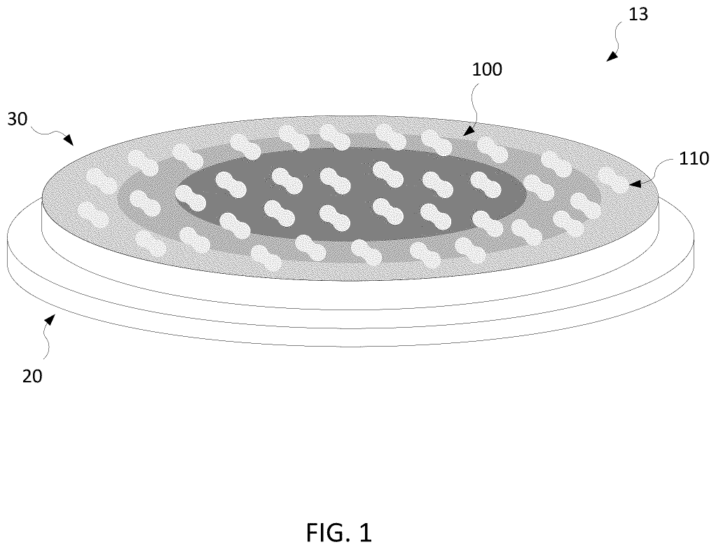

FIG. 1 illustrates a schematic view of a multidirectional optical element according to some embodiments of the present disclosure. The contents shown in FIG. 1 are provided only for illustrating embodiments of the present disclosure and should not be construed as any limitations on the claimed invention.

As shown in FIG. 1, the multidirectional optical element 13 may comprise a substrate 20 and a metalens 30. The metalens 30 may be disposed on the substrate 20, and the metalens 30 may comprise a metastructure 100. The metastructure 100 may comprise a concentric structure consisting of nanorods arranged in the sub-wavelength regime. The radius of the nanorod and each concentric circle is designed to create a desired phase profile on the metalens, and the nanorods for each concentric circle is arranged based on the same phase distribution. In addition, the metastructure 100 may be designed to comprise a pattern 110 (shown as a dog-bone-like pattern for example) of a diffractive optical element (not shown). More specially, a phase distribution of the multidirectional optical element 13 is composed of phase distributions of the concentric structure of the metastructure 100 and the pattern 110 of the diffractive optical element. In doing so, the multidirectional optical element 13 has the same size as a traditional metalens, but it can function as a traditional metalens and a traditional DOE together.

In some embodiments, the pattern 110 the diffractive optical element presented on the metastructure 100 may be, but not limited to, one of a dog-bone-like pattern, a fish-bone-like pattern, a bird-like pattern and a fishing-net-like pattern. As known, different patterns may generate different amounts of divergent points (focuses) with different arrangements. For example, the dog-bone-like pattern may generate nine (9) focuses, the fish-bone-like pattern may generate twenty-four (21) focuses, the bird-like pattern may generate twenty-five (25) focuses, and the fishing-net-like pattern may generate fifty-one (51) focuses.

The metalens 30 and substrate 20 may be made of various known materials. In some embodiments, the metalens 30 and substrate 20 may be primarily made of glass. For different applications, the metalens 30 may be primarily made of other dielectric materials (e.g., Titanium Dioxide, Niobium(V) Oxide, Zinc Oxide, Silicon, Silicon Nitride, Indium Gallium Oxide, or Gallium Nitride, etc.).

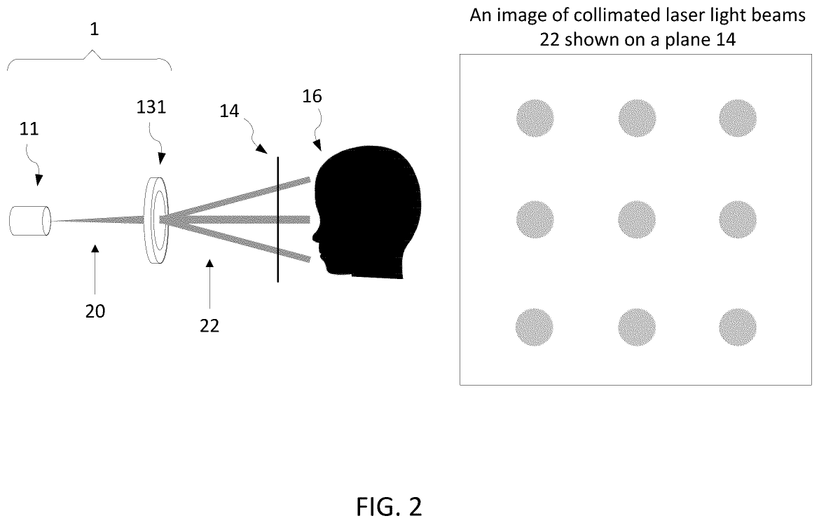

In some embodiments, the multidirectional optical element 13 may be used as a kind of diffractive optical element. For example, the multidirectional optical element 13 may be designed as a special diffractive optical element 131 and applied to a diffractive optical system 1 as shown in FIG. 2. FIG. 2 illustrates a schematic view of the diffractive optical system 1 according to some embodiments of the present disclosure, and the contents shown in FIG. 2 are provided only for illustrating embodiments of the present disclosure and should not be construed as any limitations on the claimed invention.

Referring to FIG. 2, the diffractive optical system 1 may comprise a laser 11 and the special diffractive optical element 131. The laser 11 may be implemented as various known lasers and configured to generate a laser light beam 20 that is divergent. For example, the laser 11 may be a vertical cavity surface emitting Laser (VCSEL) in some embodiments. The special diffractive optical element 131 may be configured to convert the laser light beam 20 into a plurality of collimated laser light beams 22 towards a plurality of focuses respectively. For example, it can be observed that there are nine (9) collimated laser light beams 22 passing through an plane 14 as shown in FIG. 2. The amount and arrangement of the focuses depend on what kind of pattern is presented on the metastructure 100 of the special diffractive optical element 131. For example, the dog-bone-like pattern presented on the metastructure 100 as shown in FIG. 1 can make the laser beam generated by the laser 11 converge at nine (9) focuses with a 3×3 arrangement.

In some embodiments, the diffractive optical system 1 may be adopted for facial recognition. In these embodiments, the special diffractive optical element 131 may be configured to convert the laser light beam 20 into a plurality of collimated laser light beams 22 towards a human face 16 to collect the facial features for recognition, as shown in FIG. 2. The diffractive optical system 1 may be adopted for other applications such as surface profilometry.

As compared with a traditional diffractive optical system which requires a traditional lens (plastic lens in common) to guide a laser beam into a traditional DOE, the diffractive optical system 1 has smaller size, because the special diffractive optical element 131 used in the diffractive optical system 1 is smaller than the traditional lens. In addition, it is easier to deal with light alignment in the diffractive optical system 1, because there is the only space between the laser 11 and the special diffractive optical element 131 need to be considered for the light alignment. In contrast, it is necessary for the traditional diffractive optical system to deal with light alignment for not only the space between its laser and traditional lens but also the space between the traditional lens and its traditional DOE. Moreover, there is no problem of yellowing over time to the special diffractive optical element 131 as compared to the traditional plastic lens.

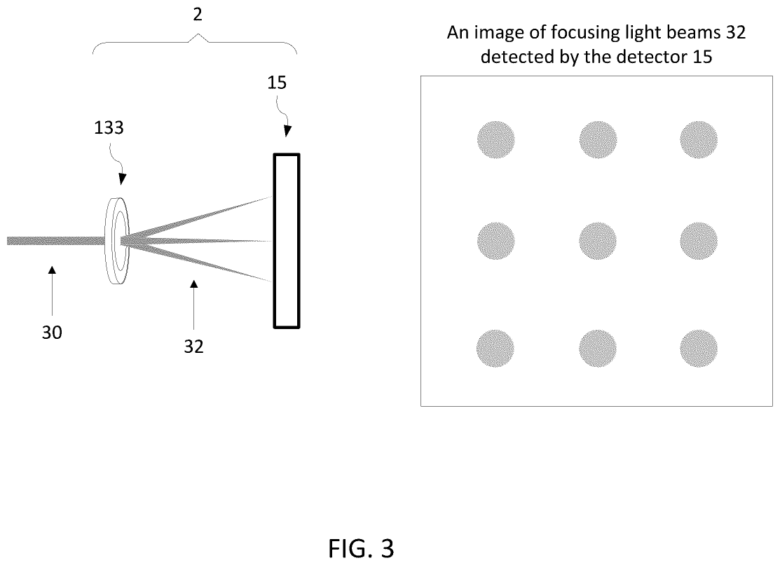

In some embodiments, the multidirectional optical element 13 may be designed as a special multidirectional lens 133 and applied to a wavefront sensor 2 as shown in FIG. 3. FIG. 3 illustrates a schematic view of a wavefront sensor according to some embodiments of the present disclosure, and the contents shown in FIG. 3 are only provided for illustrating embodiments of the present disclosure and should not be construed as any limitations on the claimed invention.

Referring to FIG. 3, the wavefront sensor 2 may comprise the special multidirectional lens 133 and a detector 15. The special multidirectional lens 133 may be configured to convert a collimated incident light beam 30 into plurality of focusing light beams 32 towards a plurality of focuses respectively, and the detector 15 may be configured to detect the focusing light beams 32 according to the focuses. For example, the dog-bone-like pattern presented on the metastructure 100 as shown in FIG. 1 can make the incident light beam converge at nine (9) focuses with a 3×3 arrangement, while the detector 15 can detect the light beam according to the nine focuses. As compared with a conventional wavefront sensor which requires a lens array composed of a plurality of traditional lenses to make the incident light beam focus on multiple divergent points for wavefront detection, the wavefront sensor 2 can make the image on the detector 15 more clear, because the special multidirectional lens 133 has a bigger numerical aperture than each lens of the lens array of the traditional wavefront sensor.

Without inconsistency with the claimed invention, a variety of combinations, modifications and/or replacements of the directly or indirectly disclosed embodiments are substantially comprised in the whole disclosure, even though they are not especially mentioned above. The scopes of the claimed invention are defined by the following claims as appended.

What is claimed is:

1. A multidirectional optical element, comprising:
a substrate; and
a metalens disposed on the substrate, comprising a metastructure, wherein the metastructure comprises a concentric structure with a pattern of a diffractive optical element.

2. The multidirectional optical element of claim 1, wherein the pattern of the diffractive optical element is one of a dog-bone-like pattern, a fish-bone-like pattern, a bird-like pattern and a fishing-net-like pattern.

3. The multidirectional optical element of claim 1, wherein the metalens and substrate are primarily made of one of glass, titanium dioxide, niobium(V) oxide, zinc oxide, silicon, silicon Nitride, indium gallium oxide, and gallium nitride.

4. The multidirectional optical element of claim 1, wherein a phase distribution of the multidirectional optical element is composed of phase distributions of the concentric structure and the pattern of the diffractive optical element.

5. The multidirectional optical element of claim 1, wherein the multidirectional optical element is used as a kind of diffractive optical element.

6. The multidirectional optical element of claim 1, wherein the multidirectional optical element is applied to a wavefront sensor.

7. A diffractive optical system, comprising:
a laser, being configured to generate a laser beam; and
a multidirectional optical element, comprising:
a substrate; and
a metalens disposed on the substrate, comprising a metastructure, wherein the metastructure comprises a concentric structure with a pattern of a diffractive optical element;
wherein the multidirectional optical element is configured to make the laser beam converge at a plurality of focuses.

8. The diffractive optical system of claim 7, wherein the laser is a vertical cavity surface emitting Laser.

9. The diffractive optical system of claim 7, wherein the pattern of the diffractive optical element is one of a dog-bone-like pattern, a fish-bone-like pattern, a bird-like pattern and a fishing-net-like pattern.

10. The diffractive optical system of claim 7, wherein the metalens and the substrate are primarily made of one of glass, titanium dioxide, niobium(V) oxide, zinc oxide, silicon, silicon Nitride, indium gallium oxide, and gallium nitride.

11. The diffractive optical system of claim 7, wherein a phase distribution of the multidirectional optical element is composed of phase distributions of the concentric structure and the pattern of the diffractive optical element.

12. The diffractive optical system of claim 7, wherein the multidirectional optical element is used as a kind of diffractive optical element.

13. The diffractive optical system of claim 7, wherein the multidirectional optical element is applied to a wavefront sensor.

14. A wavefront sensor, comprising:
a detector; and
a multidirectional optical element, comprising:
a substrate; and
a metalens disposed on the substrate, comprising a metastructure, wherein the metastructure comprises a concentric structure with a pattern of a diffractive optical element;
wherein, the multidirectional optical element is configured to make an incident light beam converge at a plurality of focuses, and the detector is configured to detect the light beam according to the focuses.

15. The wavefront sensor of claim 14, wherein the pattern of the diffractive optical element is one of a dog-bone-like pattern, a fish-bone-like pattern, a bird-like pattern and a fishing-net-like pattern.

16. The wavefront sensor of claim 14, wherein the metalens and the substrate are primarily made of one of glass, titanium dioxide, niobium(V) oxide, zinc oxide, silicon, silicon Nitride, indium gallium oxide, and gallium nitride.

17. The wavefront sensor of claim 14, wherein a phase distribution of the multidirectional optical element is composed of phase distributions of the concentric structure and the pattern of the diffractive optical element.

18. The wavefront sensor of claim 14, wherein the multidirectional optical element is used as a kind of diffractive optical element.

19. The wavefront sensor of claim 14, wherein the multidirectional optical element is applied to a wavefront sensor.
